(19) United States
(12) Patent Application Publication
(10) Pub. No.: US 2025/0348242 A1
(43) Pub. Date: Nov. 13, 2025

(54) METHOD FOR DATA MANAGEMENT IN A STORAGE DEVICE AND SYSTEM THEREOF

(71) Applicant: Samsung Electronics Co., Ltd., Suwon-si (KR)

(72) Inventors: Saigun JOSE CHIRIYANKANDATH, Bengaluru (IN); Kumar Vvnmr, Bengaluru (IN); Narasimha Rao Mavillapalli, Bengaluru (IN)

(73) Assignee: Samsung Electronics Co., Ltd., Suwon-si (KR)

(21) Appl. No.: 18/921,639

(22) Filed: Oct. 21, 2024

(30) Foreign Application Priority Data
May 13, 2024 (IN) 202441037638

(51) Int. Cl. G06F 3/06

(52) U.S. Cl. CPC G06F 3/0652; G06F 3/0604; G06F 3/0679

(57) ABSTRACT

The disclosure relates to a storage system and a method for data management in a non-volatile storage device in the storage system. The method includes configuring a logical unit in the non-volatile storage device to automatically erase data stored in the logical unit during a boot up process of a host system, and un-mapping the data stored in the logical unit based on detecting that the logical unit is configured to automatically erase data stored in the logical unit in the non-volatile storage device.

### CROSS-REFERENCE TO RELATED APPLICATION

This application is based on and claims priority to Indian patent application Ser. No. 20/244,1037638 filed on May 13, 2024, in the Indian Intellectual Property Office, the content of which is incorporated herein by reference in its entirety.

### TECHNICAL FIELD

The disclosure relates to a storage device and a method of operating the storage device, and in particular, to a method of data management and garbage collection in a storage device.

### BACKGROUND

NAND Flash-based storage devices commonly utilize Flash Translation Layers (FTLs) to manage a mapping of logical addresses to physical NAND blocks. Such NAND Flash-based storage devices may include, but is not limited to, Solid State Drives (SSD), Universal Flash Storages (UFS), embedded MultiMediaCards (eMMC), and microSD cards. These devices offer the capability for host systems to configure multiple volumes or Logical Units (LUs), with unique attributes. The FTL is responsible for efficiently managing NAND blocks, including performing garbage collection in a case in which data becomes obsolete due to new writes.

Garbage collection is a process for recovering portions of memory that no longer contain valid data. For example, in case of a flash memory, data is written to the flash memory in units called pages, which are made up of a plurality of memory cells. However, the flash memory is erased in larger units called blocks, which contains multiple pages. In a case in which some pages of a block contain invalid data, the pages containing the invalid data may not be overwritten until the entire block including the pages with the invalid data is erased. The process of garbage collection includes reading and rewriting pages having valid data from a first block into a second block and then erasing the first block. After the garbage collection, the second block contains pages with valid data and free pages available for new data to be written.

### SUMMARY

One or more aspects of the disclosure may overcome the problems discussed above. However, the disclosure is not limited thereto, and as such, one or more aspects of the disclosure may provide additional advantages.

According to one or more aspects of the disclosure, there is provided methods, systems, apparatuses and computer readable media for reducing boot time of storage devices.

According to an aspect of the disclosure, there is provided a method for data management in a non-volatile storage device including: configuring a logical unit in the non-volatile storage device to automatically erase data stored in the logical unit during a boot up process; and reserving a logical space of the logical unit for one or more applications installed on a host system.

The method may further include storing data corresponding to the one or more applications in the logical space of the logical unit.

The configuring the logical unit in the non-volatile storage device may include: adding an auto-erase flag to the logical unit in the non-volatile storage device, the auto-erase flag indicating that the data stored in the logical unit are to be discarded during the boot up process after a power reset.

According to another aspect of the disclosure, there is provided a method for data management in a non-volatile storage device including: detecting whether a logical unit in the non-volatile storage device is configured to automatically erase data stored in the logical unit during a boot up process; and un-mapping the data stored in the logical unit based on detecting that the logical unit is configured to automatically erase data stored in the logical unit in the non-volatile storage device.

The detecting that the logical unit of the non-volatile storage device is configured to automatically erase the data stored in the logical unit may include: identifying whether an auto-erase flag is added to the logical unit in the non-volatile storage device by a host system, the auto-erase flag indicating that the data stored in the logical unit are to be discarded during the boot up process after a power reset.

Based on a detection that the logical unit in the non-volatile storage device is not configured to automatically erase the data stored in the logical unit, the boot up process may be completed without un-mapping the data.

According to another aspect of the disclosure, there is provided a host system including: a non-volatile storage device; and a control circuitry coupled with the non-volatile storage device, the control circuitry configured to instruct the non-volatile storage device to: configure a logical unit in the non-volatile storage device to automatically erase data stored in the logical unit during a boot up process; and reserve a logical space of the logical unit for one or more applications installed on the host system.

According to another aspect of the disclosure, there is provided a non-volatile storage device including: a plurality of logical units; and a control circuitry coupled to the plurality of logical units, wherein the control circuitry is configured to: detect whether a logical unit, among the plurality of logical units in the non-volatile storage device, is configured to automatically erase data stored in the logical unit during a boot up process; and un-map the data stored in the logical unit based on detecting that the logical unit is configured to automatically erase data stored in the logical unit in the non-volatile storage device.

### BRIEF DESCRIPTION OF DRAWINGS

The embodiments of the disclosure are illustrated in the accompanying drawings, throughout which like reference letters indicate corresponding parts in the various figures. The embodiments herein will be better understood from the following description with reference to the drawings, in which:

FIG. 1 illustrates a high-level block diagram of a storage system according to an embodiment of the disclosure.

FIG. 2 illustrates a block diagram of a storage device according to an embodiment of the disclosure.

FIG. 3 illustrates a method of operating a storage system according to an embodiment of the disclosure.

FIG. 4 illustrates a flow chart of a method of data management in a non-volatile storage device of a host system according to an embodiment of the disclosure.

FIG. 5 illustrates a flow chart of a method of data management in a non-volatile storage device according to another embodiment of the disclosure.

### DETAILED DESCRIPTION

A problem may arise in a case in which a host application writes data that is not required after a power reset. In such cases, the information about invalidated data is not communicated to the storage device. Consequently, the device continues to accumulate this invalidated data, leading to increased garbage collection activities after multiple resets. This not only adversely affects the performance of the storage device but also significantly reduces the operational lifespan of the storage device. At least some aspects of the disclosure may address the problems that arise from the accumulation of the invalidated data and its impact on the garbage collection activities, and mitigate the adverse effects on performance and operational lifespan of the storage devices.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

According to various embodiments, the terms like “Solid State Drive,” “SSD,” and “SSD device” may be used interchangeably throughout the disclosure. Further, the terms like “host”, “host system”, and “host device” have been used interchangeably throughout the disclosure. According to various embodiments, the terms like “controller” and “processor” may be used interchangeably throughout the disclosure. According to various embodiments, the terms like “control circuitry” and “controlling unit” may be used interchangeably throughout the disclosure. According to various embodiments, the terms like “storage device”, “memory device”, “memory”, storage ”, and “non-volatile storage device” may be used interchangeably throughout the disclosure.

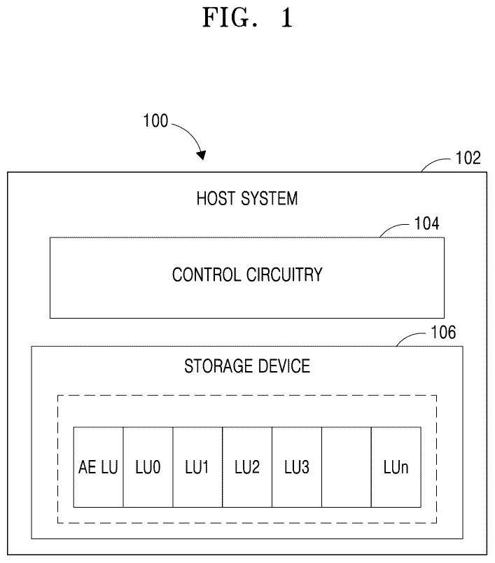

FIG. 1 illustrates a block diagram of a storage system 100 according to an embodiment. According to various embodiments of the disclosure, methods, operation and/or techniques consistent with the disclosure may be implemented on the storage system 100. As shown in FIG. 1, the storage system 100 may include a host system 102. The host system 102 may include a control circuitry 104 and a storage device 106. However, the disclosure is not limited thereto, and as such, according an embodiment, the host system 102 may include one or more other components in addition to the control circuitry 104 and a storage device 106. According to an embodiment of the disclosure, the host system 102 may be configured to control data placement and data movement operations. Although the storage device 106 is shown as integral part of the host system 102 in FIG. 1, the disclosure is not limited thererto, and as such, according to another embodiment, the storage device 106 may be outside of (or external to) the host system 102 and the host system 102 may be communicatively coupled with the storage device 106. According to an embodiment, the control circuitry 104 may include one or more processors or microcontroller along with an internal memory. The control circuitry 104 may be communicatively coupled with the storage device 106 and may control various operations of the storage device 106. For example, the various operations may include, but is not limited to, read operations, write operations, etc., of the storage device 106. The storage device 106 may be a non-volatile storage device which stores the data even after power reset or boot up. According to an embodiment, the host system 102 may be a device having a memory. For example, the host system 102 may include, but is not limited to, a computer, a laptop, a smartphone, a tablet, an embedded system, a server, a data storage system, a camera, a gaming console, a networking equipment, an electronic device, etc.

According to an embodiment, the host system 102 may configure the storage device 106. For example, the host system 102 may provide a special flag to the storage device 106 as a part of the configuration. The actual structure of configuration and the actual protocol may vary on a device by device basis. According to an embodiment, the storage device 106 may include a plurality of logical unit (LUs). Each of the plurality of logical unit (LUs) may provide a logical space to store the data. For example, the plurality of logical unit (LUs) may include LU0, LU1, LU2, LU3. . . . LUn, where n in an integer. The control circuitry 104 of the host system 102 may configure a logical unit within the storage device 106 to automatically erase data stored in the logical unit during a boot up process after power reset. The host system 102 may reserve a logical space of the logical unit for one or more applications installed on the host system 102. The one or more applications may be of a type that does not require the data after the power reset. Accordingly, by performing a configuration, the host system 102 may provide inform the storage device 106 that a specific logical unit may be considered as auto erase (e.g., AE LU). For example, the control circuitry 104 of the host system 102 may add an auto-erase flag to the logical unit of the non-volatile storage device 106 while configuring the logical unit within the non-volatile storage device 106 to automatically erase the data stored in the logical unit. The control circuitry 104 of the host system 102 may store data corresponding to the one or more applications installed on the host system 102 on the logical space of the logical unit. However, in a case in which the power reset occurs, all the data written to one or more logical units of the host system 102 that is configured as auto erase (AE) (e.g., AE LU) will be discarded. Accordingly, the host system 102 and/or the storage device 106 may reduce the accumulation of garbage data.

In this manner, the host system 102 enhances data management efficiency, mitigates the adverse effects of garbage collection activities, and consequently, extend the overall operational lifespan and performance of the storage devices. For example, the host system 102 enables an “Auto Erase” volume to provide a dedicated space for data that does not require persistence beyond a device reset. This feature allows the host system to proactively manage data that becomes obsolete, thereby reducing the accumulation of invalidated data and minimizing the frequency of garbage collection cycles. This may also optimize the utilization of storage resources and improve responsiveness of the storage device to dynamic data storage requirements.

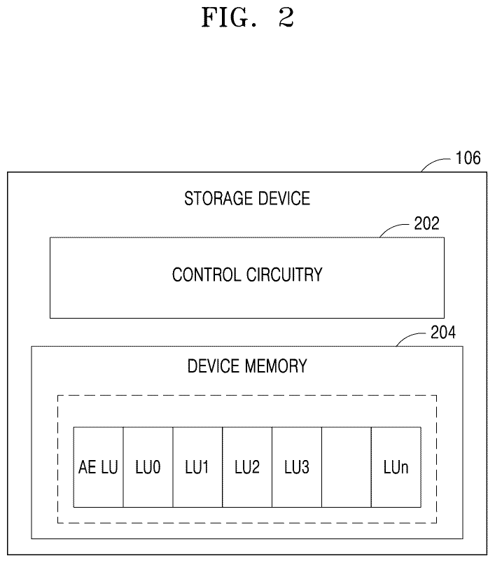

FIG. 2 illustrates a block diagram of the storage device 106 according to an embodiment. According to various embodiments of the disclosure, methods, operation and/or techniques consistent with the disclosure may be implemented by the storage device 106. The storage device 106 may include at least one device control circuitry 202 and the device memory 204. The device control circuitry 202 may be a storage controller or a processor. The device memory 204 may be a non-volatile storage media or memory (NVM) configured to process, access or store data based on requests from the host system 102. For example, in response to receiving a request from the host system 102 or an external device, the device memory 204 may access, process or store the data. As an example, the storage device 106 may include at least one of an SSD, an embedded memory, and a removable external memory. In an example case in which the storage device 106 is an SSD, the storage device 106 may be a device that conforms to the Non-Volatile Memory Express (NVMe) protocol. However, the disclosure is not limited thereto and in general, the techniques of the disclosure may be equally applicable to storage devices which conform to any other storage protocol(s) which is/are already existing or which may be developed in future. In an example case in which the storage device 106 is an embedded memory or an external memory, the storage device 106 may be a device that conforms to a Universal Flash Storage (UFS) standard or an Embedded Multimedia Card (eMMC) standard, but not limited thereto.

According to an embodiment, the storage device 106 of FIGS. 1 and 2 serves as a non-volatile storage device configured to store data regardless of whether power is supplied or not. The device memory 204 may include a flash memory which may include a 2D NAND memory array or a 3D (or vertical) NAND (VNAND) memory array. As another example, the storage device 106 may include various other kinds of NVMs. According to an embodiment, the device memory 204 may include a plurality of logical unit (LUs), each of which may typically provide a logical space to store the data. In FIG. 2, only few LUs are shown as a part of the storage device 130. However, the disclosure is not limited thereto and in general, the storage device 106 may include a plurality of LUs each connected the control circuitry 202 via one of a plurality of channels.

According to an embodiment, the storage device 106 may be physically separated from the host control circuitry 104. However, the disclosure is not limited thereto, and as such, the storage device 106 may be implemented in the same package as the host control circuitry 104 resulting in a compact storage system. The storage device 106 may be removably coupled with the host system 102 through one or more interfaces (I/F) of the storage control circuitry 202. For example, the one or more I/Fs may include, but is not limited to, a host interface and a storage device interface (or memory interface). The host interface and the storage device interface may be configured to enable exchange of read/write (I/O) requests and data between the host system 102 and the storage device 106. The host interface may be communicatively coupled with the host system 102 and the storage device interface may be communicatively coupled with the device memory 204. As an example, the host interface may transmit packets to the host system 102 and receive packets from the host system 102. For example, a packet transmitted from the host system 102 to the host interface may include a command or data corresponding to the LUs, and a packet transmitted from the host interface to the host system 102 may include a response to the command or data related to the LUs. For example, the packet transmitted from the host system 102 to the host interface may include a command or data to be written to the LUs, and the packet transmitted from the host interface to the host system 102 may include a response to the command or data read from the LUs. The device interface may transmit data to be written to the LUs or receive data read from the LUs. The device interface may be configured to comply with a standard protocol, such as Toggle or Open NAND Flash Interface (ONFI). As an example, the device interface may be implemented using various interface technologies, such as Advanced Technology Attachment (ATA), Serial ATA (SATA), external SATA (e-SATA), Small Computer Small Interface (SCSI), Serial Attached SCSI (SAS), Peripheral Component Interconnection (PCI), PCI express (PCIe), NVMe, a Universal Serial Bus (USB) interface, a Secure Digital (SD) card interface, a Multi-Media Card (MMC) interface, an eMMC interface, a UFS interface, an embedded UFS (eUFS) interface, and a Compact Flash (CF) card interface, but not limited thereto. As an example, the host interface may be a PCIe for connecting peripherals, such as NVMe-based storage device with the host system 102.

The storage control circuitry 202 may include one or more components such as a Central Processing Unit (CPU), a flash translation layer (FTL), a packet manager, a buffer memory, one or more registers, an Error Correction Code (ECC) engine, and an Advanced Encryption Standard (AES) engine. However, the disclosure is not limited thereto, and as such, the storage control circuitry 202 may include one or more other components. The control circuitry 202 may include a working memory in which the FTL is loaded. The CPU may execute the FTL to control data write and read operations on the LUs. The FTL may perform various functions including, but not limited to, an address mapping operation, a wear-leveling operation, and a garbage collection operation. The address mapping operation may be an operation of converting a logical address received from the host system 102 into a physical address used to actually store data in the storage device 106. In addition to the techniques disclosed in the disclosure to reduce the burden of the garbage collection process, a related art garbage collection operation may be used for ensuring usable capacity in the storage device 106 by erasing an existing block after copying valid data of the existing block to a new block.

In an example case in which the storage device 106 is connected for the first time with the host system 102, the storage device 106 and the host system 102 may need to follow a series of operations for establishing a functional connection between the storage device 106 and the host system 102. Such series of operations may be referred to as “an initialization sequence” or “a boot sequence” which involves a plurality of steps or configuration operations that need to be performed to ensure that the storage device 106 is in a ready state to send and/or receive data. The plurality of configuration operations (as defined in the relevant NVMe specifications) typically involve host based configuration operations related to initialization of the control circuitry 202 which include memory allocations and configurations of the control circuitry 202.

According to an embodiment, the control circuitry 202 may be detect whether a logical unit (LU) among the plurality of logical units (LUs) of the non-volatile storage device is configured to automatically erase (AE) data stored in the logical unit during a boot up process after power reset. The control circuitry 202 may identify whether an auto-erase flag is added to the logical unit of the non-volatile storage device 106 in order to detect that the logical unit of the non-volatile storage device is configured to automatically erase the data stored in the logical unit. The auto-erase flag is added to the logical unit by the host system 102. The control circuitry 202 may un-map the data stored in the logical unit upon detecting that the logical unit being configured within the non-volatile storage device 106. On the other hand, upon detecting that the logical unit of the non-volatile storage device 106 is not configured to automatically erase the data stored in the logical unit, the control circuitry 202 may complete the boot up process without un-mapping the data stored in the logical unit. The boot up process may be initiated based on a criteria being satisfied. For example, the boot up process may be initiated after every power cycle (e.g., after system reset, system restarting, etc.) which may be due to various factors such as power disruptions, server maintenance. However, the disclosure is not limited thereto, and as such, according to another embodiment, the boot up process may be initiated based on another condition being satisfied. According to an embodiment, a power cycle may be defined as an event in which power is turned off to the storage device 106 and then turned on again (e.g., in a case in which the system is booted up for the first time or powered up following a reset or restart).

In this manner, data management efficiency is enhanced, the adverse effects of garbage collection activities are mitigated, and consequently, the overall operational lifespan and performance of these storage devices are extended. The “Auto Erase” volume provides a dedicated space for data that does not require persistence beyond a device reset. This feature allows for proactive management of data that becomes obsolete, thereby reducing the accumulation of invalidated data and minimizing the frequency of garbage collection cycles. This also may optimize the utilization of storage resources and improve the device's responsiveness to dynamic data storage requirements.

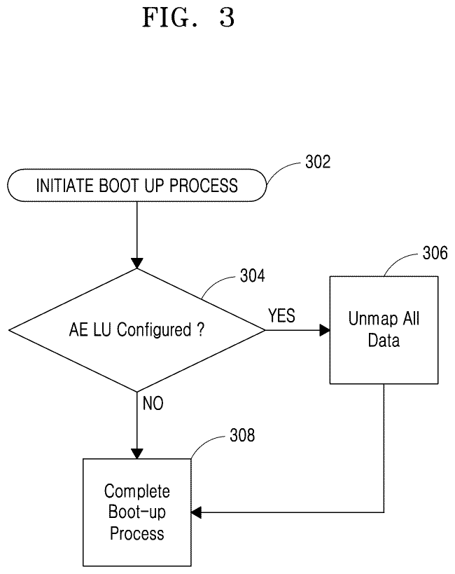

FIG. 3 illustrates a method of operating a storage system according to an embodiment of the disclosure. For example, the method may include operational procedure 300 for reducing the accumulation of invalidated data and minimizing the need for the garbage collection activities according to an embodiment.

According to an embodiment, in operation 302, the method may include performing an initiation of a boot-up process of the host system 102. For example, the host system 102 may initiate the boot-up process. For example, the boot-up process may be during system startup or system reset/restart, but the disclosure is not limited thereto. In operation 304, the method may include detecting or determining whether a logical unit (LU) of the non-volatile storage device 106 is configured as auto-erase (AE) LU to automatically erase data stored in the logical unit. For example, the storage device 106 may detect or determine whether a logical unit (LU) of the non-volatile storage device 106 is configured as auto-erase (AE) LU to automatically erase data stored in the logical unit. In operation 304, the method may include un-mapping the data stored in the LU configured as auto-erase (AE) LU. For example, upon detecting that the logical unit is configured as the AE LU, the storage device 106 may un-map the data stored in the AE LU. For example, the data in the AE LU may be discarded. In operation 308, the method may include completing the boot up process. For example, the host system end the operational procedure 300 by completing the boot-up process. On the other hand, in a case in which the LU is not configured as the AE LU, the operational procedure 300 may include directly completing the boot-up process in operation 308 without performing operation 306.

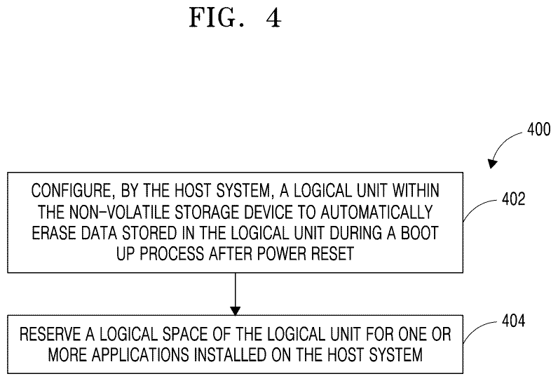

FIG. 4 illustrates a flow chart of a method 400 of data management in a non-volatile storage device of a host system 102 according to an embodiment. For example, the method 400 may be for reducing the accumulation of invalidated data and minimizing the need for the garbage collection activities. The various operational procedures of FIG. 4 may be performed using host system 102. For example, the operational procedures of FIG. 4 may performed using the control circuitry 104 which is communicatively coupled with the storage device 106.

In operation 402, the method may include configuring one or more logical units (LUs) to automatically erase data stored in the one or more logical units (LUs) during a boot up process. For example, the host system 102 may configure one or more logical units (LUs) within the non-volatile storage device 106 to automatically erase data stored in the one or more logical units (LUs) during a boot up process after power reset. According to an embodiment, the host system 102 may add an auto-erase flag to the logical unit of the non-volatile storage device 106 while configuring the logical unit to automatically erase the data stored in the logical unit. In operation 404, the method 400 may include reserving a logical space of the logical unit for one or more applications installed on the host system. The method may further include storing data pertaining to the one or more applications installed on the host system 102 on the logical space of the logical unit.

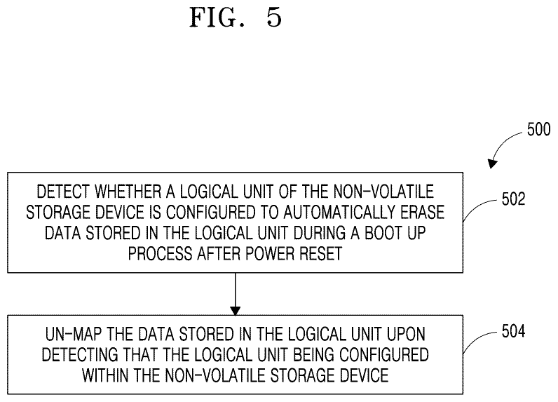

FIG. 5 illustrates a flow chart of a method 500 of data management in a non-volatile storage device of a host system 102 according to an embodiment. For example, the method 400 may be for reducing the accumulation of invalidated data and minimizing the need for the garbage collection activities. The various operational procedures of FIG. 5 may be performed using the storage device 106. For example, the various operational procedures of FIG. 5 may be performed using the control circuitry 202 which is communicatively coupled with the host system 102.

In operation 502, the method may include detecting whether a logical unit of the non-volatile storage device is configured to automatically erase data stored in the logical unit during a boot up process after power reset. The detection that the logical unit is configured to automatically erase the data stored in the logical unit may include determining whether an auto-erase flag is added to the logical unit of the non-volatile storage device. The auto-erase flag may be added to the logical unit by the host system 102 during configuration of the storage device 106. In operation 504, the method may include un-mapping the data stored in the logical unit upon detecting that the logical unit being configured within the non-volatile storage device. In an example case in which the logical unit of the non-volatile storage device is not configured to automatically erase the data stored in the logical unit, the method may include completing the boot up process without un-mapping the data.

According to one or more aspects of the disclosure, there is provide methods, operations and techniques for managing data persistence in NAND-based storage devices. A unique volume (of a storage device) with an “Auto Erase” feature as described herein, allows the host system to allocate storage space from this volume for data that does not need to be persistent after a device reset. This provides a mechanism for the host to inform the storage device explicitly about data that is no longer required, thereby reducing the accumulation of invalidated data and minimizing the need for garbage collection activities. Consequently, the proposed method aims to improve the overall performance and extend the lifespan of NAND-based storage devices.

According to an embodiment, the methods, operations and techniques not only address the above described issues related to data management and garbage collection but also is applicable to future challenges, offering a comprehensive and forward-looking solution for NAND Flash-based storage devices. The technique of the disclosure significantly enhances the reliability, performance, and overall user experience in a wide range of applications where NAND Flash storage is a fundamental component.

The flowcharts illustrated in FIGS. 4 and 5 may be described in the general context of computer executable instructions. Generally, computer executable instructions can include routines, programs, objects, components, data structures, procedures, modules, and functions, which perform specific functions or implement specific abstract data types.

The order in which the various operations of the operational procedures are described is not intended to be construed as a limitation, and any number of the described operational procedure blocks can be combined in any order to implement the operational procedure. Additionally, individual blocks may be deleted from the operational procedures without departing from the spirit and scope of the subject matter described herein. Furthermore, the operational procedures can be implemented in any suitable hardware, software, firmware, or combination thereof.

The operational procedures described above may be performed by any suitable means capable of performing the corresponding functions. The means may include various hardware and/or software component(s) and/or module(s) shown in FIGS. 1 and 2. For example, in a case in which there are operations illustrated in Figures, these operations may have corresponding counterpart means-plus-function components. It may be noted here that the subject matter of some or all embodiments described with reference to FIGS. 1-3 may be relevant for the operational procedures 400, 500 and the same is not repeated for the sake of brevity. Further, the disclosure has been explained by considering the storage device as NVMe SSDs. However, it may be noted that the teachings of the disclosure are equally applicable for other types of storage devices as well.

According to an embodiment of the disclosure, one or more non-transitory computer-readable media may be utilized for implementing the embodiments consistent with the disclosure. Certain aspects may include a computer program product for performing the operations presented herein. For example, such a computer program product may include a computer readable media having instructions stored (and/or encoded) thereon, the instructions being executable by one or more processors to perform the operations described herein. For certain aspects, the computer program product may include packaging material.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

1. A method for data management in a non-volatile storage device comprising:
configuring a logical unit in the non-volatile storage device to automatically erase data stored in the logical unit during a boot up process; and
reserving a logical space of the logical unit for one or more applications installed on a host system.

2. The method of claim 1, further comprises storing data corresponding to the one or more applications in the logical space of the logical unit.

3. The method of claim 1, wherein the configuring the logical unit in the non-volatile storage device comprises:
adding an auto-erase flag to the logical unit in the non-volatile storage device, the auto-erase flag indicating that the data stored in the logical unit are to be discarded during the boot up process after a power reset.

4. A method for data management in a non-volatile storage device comprising:
detecting whether a logical unit in the non-volatile storage device is configured to automatically erase data stored in the logical unit during a boot up process; and
un-mapping the data stored in the logical unit based on detecting that the logical unit is configured to automatically erase data stored in the logical unit in the non-volatile storage device.

5. The method of claim 4, wherein the detecting that the logical unit of the non-volatile storage device is configured to automatically erase the data stored in the logical unit comprises:
identifying whether an auto-erase flag is added to the logical unit in the non-volatile storage device by a host system, the auto-erase flag indicating that the data stored in the logical unit are to be discarded during the boot up process after a power reset.

6. The method of claim 4, wherein based on a detection that the logical unit in the non-volatile storage device is not configured to automatically erase the data stored in the logical unit, the boot up process is completed without un-mapping the data.

7. A host system comprising:
a non-volatile storage device; and
a control circuitry coupled with the non-volatile storage device, the control circuitry configured to instruct the non-volatile storage device to:
configure a logical unit in the non-volatile storage device to automatically erase data stored in the logical unit during a boot up process; and
reserve a logical space of the logical unit for one or more applications installed on the host system.

8. The host system of claim 7, wherein the control circuitry is further configured to store data corresponding to the one or more applications installed on the host system in the logical space of the logical unit.

9. The host system of claim 7, wherein the control circuitry is further configured to add an auto-erase flag to the logical unit in the non-volatile storage device, the auto-erase flag indicating that the data stored in the logical unit are to be discarded during the boot up process after a power reset.

10-12. (canceled)
